(19) United States
(12) Patent Application Publication
(10) Pub. No.: US 2018/0006833 A1
(43) Pub. Date: Jan. 4, 2018

(54) SYSTEM AND METHOD FOR CONTROLLER-INITIATED SIMULTANEOUS DISCOVERY OF THE CONTROL TREE AND DATA NETWORK TOPOLOGY IN A SOFTWARE DEFINED NETWORK

(71) Applicant: ARGELA YAZILIM VE BILISIM TEKNOLOJILERI SAN. VE TIC. A.S., ISTANBUL (TR)

(72) Inventors: SINAN TATLICIOGLU, ISTANBUL (TR); SEYHAN CIVANLAR, ISTANBUL (TR); ERHAN LOKMAN, ISTANBUL (TR); BURAK GORKEMLI, ISTANBUL (TR); METIN BALCI, ISTANBUL (TR); BULENT KAYTAZ, ISTANBUL (TR)

(21) Appl. No.: 15/197,737

(22) Filed: Jun. 29, 2016

(51) Int. Cl. H04L 12/18; H04L 12/935; H04L 12/715; H04L 12/46; H04L 12/753; H04L 12/751; H04L 12/931; H04L 12/741

(52) U.S. Cl. CPC H04L 12/18; H04L 49/70; H04L 49/30; H04L 45/745; H04L 12/4641; H04L 45/48; H04L 45/026; H04L 45/64

(57) ABSTRACT

Controller(s) can determine a control path towards each network switch using a novel controller-originated discovery process based on an in-band control network that is an overlay on the data network. The controller attempts to connect to each switch when it does not have a readily configured control connection towards the switch. Once the controller learns about the presence of a new switch and at least one or more paths to reach that switch through aforementioned discovery process, it can select, adjust and even optimize the control path's route towards that switch. During the controller-originated control network discovery process, the controller also learns about the to connectivity between all switches. Thereby, as a by-product of the discovery process, it uncovers the entire data network topology in parallel.

### BACKGROUND OF THE INVENTION

### Field of Invention

The present invention relates generally to a system and data communication method in software defined network (SDN) and more specifically it relates to a controller-originated control-tree discovery process, when all of the switches in the SDN are not directly attached to a controller with a physically separate facility. It relates to the grafting of virtual control connections over the data network and establishment of in-band control tree(s) as an overlay to the data network. While determining the control tree topology, the discovery method of this invention simultaneously discovers the connectivity of the entire data network. It applies to both wired and wireless SDNs, and more specifically to SDN based wireless mesh networks (WMNs).

### Discussion of Related Art

Software defined networking consists of techniques that facilitate the provisioning of network services in a deterministic, dynamic, and scalable manner. SDN currently refers to the approaches of networking in which the control plane is decoupled from the data plane of forwarding functions and assigned to a logically centralized controller, which is the ‘brain’ of the network. The SDN architecture, with its software programmability, provides agile and automated network configuration and traffic management that is vendor neutral and based on open standards. Network operators, exploiting the programmability of the SDN architecture, are able to dynamically adjust the network's flows to meet the changing needs while optimizing the network resource usage.

An OpenFlow [see paper OpenFlow Protocol 1.5, Open Networking Forum (ONF)] based SDN is formed by switches that forward data packets according to the instructions they receive from one or more controllers using the standardized OpenFlow protocol. A controller configures the packet forwarding behavior of switches by setting packet-processing rules in a so-called ‘flow table’. Depending on implementation, rather than having one large ‘flow table’ there may be a pipeline made up of multiple flow tables. A rule in the flow table is composed of a match criteria and actions. The match criteria are multi-layer traffic classifiers that inspect specific fields in the packet header (source MAC address, destination MAC address, VLAN ID, source IP address, destination IP address, source port, etc.), and identify the set of packets to which the listed actions will be applied. The actions may involve modification of the packet header and/or forwarding through a defined output port or discarding the packet. Each packet stream that matches a criteria is called a ‘flow’. If there are no rules defined for a particular packet stream, the switch receiving the packet stream will either discard it or forward the packets along the control network to the controller requesting instructions on how to forward them.

The controller is the central control point of the network and hence vital in the proper operations of network switches. In a typical SDN, the controller is directly attached to each switch with physically separate facilities forming a star-topological control network in which the controller is at the center and all the switches are at the edges. OpenFlow protocol runs bi-directionally between the controller and each switch on a secure TCP channel. The control network that is physically stand-alone is called ‘out-of band’, and is separated from the data network. However, the control network may also be a secure overlay on the data network (in-band), i.e., sharing the same physical facilities with the data traffic. This more complex control network applies to both wired and wireless networks. In some networks, such as the wireless mesh networks, where links may be highly unreliable, or in networks where the switches span a large stretch of geographical area, it may not be practical to directly attach the controller to every switch with a separate facility as in the out of band control networks. A sparsely direct-connected control network may be more realistic because only a few of the larger switches such as the gateways can be directly attached to the controller while all the other switches reach the controller via neighboring switches using in-band connections overlaid on the data network.

The aforementioned sparsely direct-connected topology is particularly applicable to a Wireless Mesh Network (WMN) [see paper RFC 2501 entitled, “Mobile Ad Hoc Networking, Routing Protocol Performance Issues and Evaluation Considerations”]. Wireless mesh infrastructure is, in effect, a network of routers minus the cabling between nodes. It is built of peer radio devices that don't have to be cabled to a wired port like traditional access points do. Mesh infrastructure carries data over large distances by splitting the distance into a series of short hops. Intermediate nodes not only boost the signal, but cooperatively pass the data from point A to point B by making forwarding decisions based on their knowledge of the network, i.e., perform routing. Such architecture may, with careful design, provide high bandwidth, spectral efficiency, and economic advantage over the coverage area.

Wireless mesh networks have a relatively stable topology except for the occasional failure of nodes or addition of new nodes. The path of traffic, being aggregated from a large number of end users, changes infrequently. Practically all the traffic in an infrastructure mesh network is either forwarded to or from a gateway, while in ad hoc networks or client mesh networks the traffic flows between arbitrary pairs of nodes.

Lately, there has been some research studies in prior art implementing SDN based Wireless Mesh Network (WMN) [see paper to Chen et al. entitled, “A study on distributed/centralized scheduling for wireless mesh network”] which is comprised of many interconnected wireless switches and one or more SDN controllers. However, the work assumes that wireless switches run an Internal Gateway Protocol (IGP) to determine routing, and can concurrently receive OpenFlow instructions from the controller to differently process specific flows. Because the number of switches in a WMN is fairly large, an in-band control network is viable by directly attaching only larger WMN gateways to the controller.

In the SDN architecture a switch awakening after a series of booting processes needs to connect to the controller in order to receive the necessary forwarding instructions. Even though the IP address and the port number of the controller would be manually configured in the switch memory, if the control network is in-band under a changing topology and the switch is not running an IGP it becomes impossible for the switch to connect to the controller. Thus, the need for running an IGP [see paper to Chen et al. entitled, “A study on distributed/centralized scheduling for wireless mesh network”] stems from the need to configure the forwarding of in-band control messages between the controller and switches according to the chosen IGP, and doing so, eliminating the need for an explicit controller discovery. Discovery, in this context, means those switches that are not directly attached to the controller determining a path towards the controller. Running an IGP is considered as a stopgap in case the link toward the controller fails and switches can't receive flow tables. However, the actual benefit of SDN is the removal of the complex IGP functions such as OLSR and AODV [see paper RFC 3626 entitled, “Optimized Link State Routing (OLSR)”; and paper RFC 3561 entitled, “Ad hoc On-Demand Distance Vector (AODV) Routing”] from the wireless routers so that the new hardware-based SDN switches are much less complex, less expensive and extremely fast. Furthermore, fully relying on a centralized control mechanism allows efficient, creative and robust flow routing capabilities as the wireless network topology is changing.

The out of band control network is rather simple. The controller's layer-2/3 address is configured into each switch at the time of the initial configuration, or more controller addresses can be added at a later time using the network management interface of the switch. Since all the switches are hardwired to the controller, they can immediately start an OpenFlow dialog.

OpenFlow is a simplified protocol that has a simple finite machine model. Almost all the messages in this protocol are asynchronous, leaning they don't require a state to handle. However, the initial connection establishment procedure between the controller and a switch involves some version and capability negotiation, therefore a minimal state handling, which has to be done before any other messages can be exchanged. After the secure TLS [see paper RFC 2246 entitled, “Transport Layer Security (TLS)”] control connection is established, the switch and the controller exchange the ‘hello’ message as defined by the OpenFlow protocol. After receiving the hello message from the other end, the device determines which OpenFlow version is the negotiated version. If the version negotiation is successful, the state machine of the two ends enters into the next phase, feature discovery.

If the control network is in-band, initially a control network discovery is needed. This process determines the location of a control connection between a switch and the controller (via other switches) to send/receive OpenFlow messages. If the switches are not running an IGP, or each switch is not manually configured for a specific control connection, the switches will not know which port to forward their control packets. Even when the in-band control network is manually configured in each switch, when the data network topology changes as links and nodes go up and down, as in a WMN, the in-band control network topology changes accordingly. Therefore, there is a need for an to automatic control network discovery mechanism not only to setup the initial control network topology but also to rapidly modify the graph according to changes in the data network. This significant problem is not addressed in OpenFlow or in any prior art to our knowledge.

Embodiments of the present invention are an improvement over prior art systems and methods.

### SUMMARY OF THE INVENTION

In one embodiment, the present invention provides a method as implemented in a controller in a software defined network (SDN), the controller storing an in-band control tree, the control tree spanning switches as an overlay to the SDN with the controller as the root of the control tree, the controller connected to at least a transit switch in the control tree, and the transit switch having at least one, first-degree, neighbor transit switch also in the control tree and having at least another, first-degree, neighbor switch that is not in the control tree, the method comprising: (a) transmitting, to the transit switch, a packet-out message with an LLDP packet as its payload, wherein the transit switch: receives the packet-out message, extracts the LLDP packet from its payload, and multicasts the LLDP packet through all its active ports to the neighbor transit switch and neighbor switch; (b) receiving, from the neighbor transit switch in the control tree, a first packet-in message, with the first packet-in message being generated by the neighbor transit switch using the received LLDP packet as the payload; (c) receiving, from the neighbor switch not in the control tree, a second packet-in message with a hello message as its payload, with the second packet-in message being sent over the same port in the neighbor switch that received the LLDP packet transmitted in (a) and via the transit switch connected to the controller which then forwards the second packet-in message to the controller; (d) adding a new link to the control tree for the neighbor switch that sent the second packet-in message in (c).

In another embodiment, the present invention provides a method as implemented in a transit switch in a software defined network (SDN), the SDN further comprising a controller storing an in-band control tree, the control tree spanning switches as an overlay to the SDN with the controller as the root of the control tree, the controller connected to at least the transit switch in the control tree, and the transit switch having at least one, first-degree, neighbor transit switch also in the control tree and having at least another, first-degree, neighbor switch that is not in the control tree, the method comprising: (a) receiving, from the controller, a packet-out message with an LLDP packet as its payload; (b) extracting the LLDP packet from the payload of the packet-out message; (c) multicasting the LLDP packet through all active ports of the transit switch to the neighbor transit switch and neighbor switch, wherein the neighbor transit switch in the control tree generates and transmits, to the controller, a first packet-in message using the received LLDP packet as the payload; (d) receiving a second packet-in message from a neighbor switch not in the control tree, with the neighbor switch generating and transmitting the packet-in message with a hello message as its payload, where the packet-in message is sent over the same port in the neighbor switch that received the LLDP packet transmitted in (c); and (e) forwarding the packet-in message to the controller, wherein the controller adds a new link to the control tree for the neighbor switch that sent the second packet-in message.

In yet another embodiment, the present invention provides a controller in a software defined network (SDN), the controller storing an in-band control tree, the control tree spanning switches as an overlay to the SDN with the controller as the root of the control tree, the controller connected to at least a transit switch in the control tree, and the transit switch having at least one, first-degree, neighbor transit switch also in the control tree and having at least another, first-degree, neighbor switch that is not in the control tree, the controller comprising: (a) a control discovery subsystem, which initiates and manages control network discovery, and: (1) generates and transmits, to the transit switch, a packet-out message with an LLDP packet as its payload, wherein the transit switch: receives the packet-out message, extracts the LLDP packet from its payload, and multicasts the LLDP packet through all its active ports to the neighbor transit switch and neighbor switch, (2) receives, from the neighbor transit switch in the control tree, a first packet-in message, with the first packet-in message being generated by the neighbor transit switch using the received LLDP packet as the payload, and (3) receives, from the neighbor switch not in the control tree, a second packet-in message with a hello message as its payload, with the second packet-in message being sent over the same port in the neighbor switch that received the LLDP packet transmitted in (1) and via the transit switch connected to the controller which then forwards the second packet-in message to the controller; (b) a topology discovery subsystem that derives the existence of connections between switches based on received first and second packet-in messages by the control discovery subsystem; and (c) a topology database storing data network and control tree topologies.

In an extended embodiment, the controller further comprises a control network optimizer which evaluates the control tree and initiates reconfiguration of the control tree.

In an extended embodiment, the controller further comprises a control network measurement collector which collects measurements from switches in the SDN to evaluate quality of existing in-band control channels.

In an extended embodiment, the controller further comprises a control flow table generator which generates a control flow table for each switch in the control tree.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIGS. 1 to 3 illustrate a step-by-step controller discovery process on a simple exemplary network.

FIG. 4 illustrates a two-controller network with overlay control channels distinguished by the use of different VLAN IDs.

FIG. 5 illustrates a high-level block diagram of the controller.

FIGS. 6A and 6B illustrate a simple flow chart of the discovery process.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

An electronic device (e.g., a network switch or controller) stores and transmits (internally and/or with other electronic devices over a network) code (composed of software instructions) and data using machine-readable media, such as non-transitory machine-readable media (e.g., machine-readable storage media such as magnetic disks; optical disks; read only memory; flash memory devices; phase change memory) and transitory machine-readable transmission media (e.g., electrical, optical, acoustical or other form of propagated signals—such as carrier waves, infrared signals). In addition, such electronic devices include hardware, such as a set of one or more processors coupled to one or more other components—e.g., one or more non-transitory machine-readable storage media (to store code and/or data) and network connections (to transmit code and/or data using propagating signals), as well as user input/output devices (e.g., a keyboard, a touchscreen, and/or a display) in some cases. The coupling of the set of processors and other components is typically through one or more interconnects within the electronic devices (e.g., busses and possibly bridges). Thus, a non-transitory machine-readable medium of a given electronic device typically stores instructions for execution on one or more processors of that electronic device. One or more parts of an embodiment of the invention may be implemented using different combinations of software, firmware, and/or hardware.

As used herein, a network device such as a switch, or a controller is a piece of networking equipment, including hardware and software that communicatively interconnects other equipment on the network (e.g., other network devices, end systems). Switches provide multiple layer networking functions (e.g., routing, bridging, VLAN (virtual LAN) switching, Layer 2 switching, Quality of Service, and/or subscriber management), and/or provide support for traffic coming from multiple application services (e.g., data, voice, and video). A network device is generally identified by its media access (MAC) address, Internet protocol (IP) address/subnet, network sockets/ports, and/or upper OSI layer identifiers.

Note while the illustrated examples in the specification discuss mainly on SDN system, embodiments of the invention may be implemented in non-SDN system. It can be implemented in any layered network architecture such as a Network Function Virtualization (NFV) architecture wherein there is control infrastructure separated from data handling. Unless specified otherwise, the embodiments of the invention apply to any controller of the layered network architecture, i.e., they are NOT limited to an SDN controller.

The method and system of this invention allows the controller(s) to determine a control path towards each network switch wherein, a novel controller-originated discovery is performed. The present invention considers an in-band control network that is an overlay on the data network. It is topologically tree forming, wherein each controller is the root of the tree, and messages from the root to any switch pass through to other (transit) switches along the control tree.

According to this invention, the controller attempts to connect to each switch when it does not have a readily configured control connection towards the switch. Once the controller learns about the presence of a new switch and at least one or more paths to reach that switch through aforementioned discovery process, it can select, adjust and even optimize the control path's route towards that switch. During the controller-originated control network discovery process, the controller also learns about the connectivity between all switches. Thereby, as a by-product of the discovery process, it uncovers the entire data network topology in parallel.

Components of the Control Network: As a general concept, we assume that the control network of an SDN is comprised of

(1) one or more controllers that are reliably and securely interconnected to share control information. These controllers may be in a master-slave configuration, or operate as peers in a load sharing setup. The interconnection between controllers is out of scope.

(2) secure, direct and out-of-band control connections to a set of the switches, and

(3) secure, indirect, and in-band (overlay) control connections to the rest of the switches.

A switch's indirect control connection to the controller is comprised of a concatenation of a direct connection and one or more overlay control channels (OCCs), each channel configured on the facility that carries data traffic.

One of the key requirements for the overlay control network is that it must be securely isolated from the data traffic on the same facility. Furthermore, when there are several controllers, the control connections emanating from each switch towards different controllers must be distinguishable.

SDN advocates the concept of a ‘flow’, which is nothing but a stream of packets that are treated in a certain way specified by the controller in each switch. Therefore, we can plausibly treat the in-band control network just like any flow (call it a ‘control flow’) for which match criteria and rules are defined. The packets in this flow are OpenFlow messages either transiting through or terminating at a switch. However, given the control flow must be highly secure and therefore must be treated in an isolation from the data traffic, we alternatively propose to model it as a control VLAN [see paper titled, “Virtual LAN (VLAN)”] on the SDN data network. Electing this approach though does not rule out a ‘flow’ based modeling for the control channel, since the same general concepts of discovery applies to both.

Using a control VLAN: According to the present invention, a control VLAN is proposed as a controller-specific overlay network between a controller and all switches. When there are multiple controllers, a separate VLAN per controller is formed. Each VLAN connection is a secure channel defined by OpenFlow (e.g., using TCP/TLS [see paper RFC2246 entitled, “Transport Layer Security (TLS)]). The forwarding of control packets between the controller and the switches is, therefore, performed at layer-2, i.e., no layer-3 routing is needed. Although one may argue that the Ternary Content Addressable Memory (TCAM) implementation in SDN switches make the layer-2 and layer-3 packet processing almost identical in performance, a TCAM can only hold a handful of flows (few thousand in current implementations), wherein rest of the flows unfortunately are processed in software. When TCAM is used for layer-2 flows only, however, its flow processing capacity is more than tenfold increased according to the literature [see IBM Research paper to Kannen et al. entitled, “Compact TCAM: Flow Entry Compaction in TCAM for Power Aware SDN”]. Therefore, using the layer-2 routing for control network presents such an advantage.

In order to differentiate the control VLANs of different controllers, we can make each control VLAN a ‘tagged’ VLAN with an associated VLAN ID (VID). If there is only one controller and therefore there is only one control VLAN, then tagging may not be essential. However, if the SDN supports other untagged data VLANs in addition to the control VLAN, then tagging can be used as a mechanism to differentiate the control VLAN traffic from all other VLANs. The in-band control network discovery problem we posed earlier becomes the problem of network switches discovering the controller of each control VLAN as the data network topology is changing.

Tagged VLAN: To support tagged VLANs, a simple 4-byte tag is inserted into the header of a VLAN Ethernet packet. Standards define it as a 2 bytes of Tag Protocol Identifier (TPID) and 2 bytes of Tag Control Information (TCI): TPID is the tag protocol identifier, which indicates that a tag header is following and contains the user priority, canonical format indicator (CFI), and the VLAN ID. User priority is a 3-bit field that allows priority information to be encoded in the frame. Eight levels of priority are allowed, where zero is the lowest priority and seven is the highest priority. The CFI is a 1-bit indicator that is always set to zero for Ethernet switches. The 12-bit VID field is the identifier of the VLAN. Actually, it is only the VID field that is really needed for distributing VLANs across many switches.

Control Flow Table: The switches are simple packet forwarding devices whose sole function is fast packet relaying according to the set of rules provided by the controller. When no rules are provided, the switch does not know where to forward packets. So, configuring ports with VLAN IDs or IP numbers is not sufficient to make the switch function as a layer-2/3 forwarding device. It needs the matching criteria and rules to determine where and how to the forward packets. The prior art defines flow tables only for data packets (or flows) because the forwarding path of control packets between a controller and switch is physically separated when they are hardwired. However, in an in-band control tree, wherein there are other transit switches along the path between the controller and a switch, the controller has to instruct each switch (i) how to forward control packets upward towards the controller, and (ii) how to forward control packets downward towards the switch recipient of the control message. The ‘control flow table’ concept is essentially the collection of forwarding rules associated with solely the control traffic, by which a clear distinction is made to ‘data flow table(s)’ that define how user packets are forwarded.

Controller-Originated Discovery Process: According to the invention, each controller in the network attempts to discover the topology of an overlay control tree. Meanwhile, it uncovers the data network topology, i.e., the connectivity between switches. Essentially, the controller determines the location of an overlay control channel that enables a switch to have an end-to-end control path towards the controller.

According to the proposed method of this patent, the controller periodically sends each switch connected to itself an LLDP [see paper entitled, “Link Layer Discovery Protocol (LLDP)”] packet enveloped by a packet-out header. Each switch receiving the packet-out message will strip the packet-out header and broadcasts the LLDP packet from all its active ports. If a VLAN is used for the control network, this message will have the VLAN ID associated with the specific controller. The LLDP packet is sent to a special bridged multicast address with a time-to-live (TTL) value “1” and therefore it will not be flooded beyond the first-order neighbors of the LLDP sender. The switches that are active but do not have a connection to the controller will listen to the multicast address to receive LLDP messages. Generally speaking, OpenFlow uses the controller-originated LLDP messages to discover the data network topology (i.e., links between switches). We will exploit this mechanism to set up the control tree along with data network topology.

The treatment of the LLDP packet according to an aspect of this invention is as follows:
1) First, the controller sends a packet-out message with an LLDP packet as the payload to each of its directly attached switches. These switches are obviously on the control tree. The root of the tree is the controller.
2) When the switch receives the packet-out message from the controller and extracts the LLDP packet from its payload, it multicasts it through all its active ports to its first order neighbors (except the port from which it received the LLDP packet). While sending the LLDP packet, the source address field is set to the MAC address of the outgoing switch port. For example, if there are four outgoing ports on the switch, then four LLDP messages, each with a specific outgoing port's MAC address as the source address, are generated. By changing the LLDP source address to that of the outgoing port, we eliminate the need for the controller to send one LLDP packet for each port of the switch. The OpenFlow instructions the controller sends the switch tells the switch what to do with an incoming LLDP packet received in a packet-out. Let us call a switch, which has a control path towards the controller, a ‘transit switch’. A first-degree neighbor switch of a transit switch that is on the control tree is called a ‘neighbor transit switch’. A first-order neighbor of a transit switch receiving an LLDP from that transit switch but does not have any readily configured (or direct) control connection towards the controller is called a ‘neighbor switch’.
3) When a ‘neighbor transit switch’ (i.e., on the control tree) receives the LLDP packet, it generates a packet-in with the received LLDP packet as the payload and forwards the packet towards the controller along the control tree. Any transit switch along the path between the neighbor transit switch generating the packet-in and the controller has been readily provided OpenFlow instructions by the controller as to where to forward a received packet-in to reach the controller. When the packet-in arrives, the controller extracts the source MAC address of the packet-in (the neighbor transit switch's MAC address) and the source MAC address of the LLDP packet (the port of the transit switch that multicasts the LLDP), and establishes the fact that there is a connection between that transit switch (port) and the neighbor transit switch. This new connection information is added to the topology database of the controller.
4) When a ‘neighbor switch’ (not on the control tree) receives the LLDP packet from a transit switch, it generates a hello message towards the controller and sends it on the port that it just had received the LLDP packet (i.e., the source port of the hello message is the port on which LLDP packet was received). The hello message is forwarded to the controller by the transit switch in a packet-in along the control tree. When the controller receives the packet-in whose payload is the hello message, it extracts the MAC address of the source port sending the hello and the MAC address of the switch generating the packet-in, thereby, derives that there is a connection between the aforementioned source port of the neighbor switch and the transit switch. That source port is also designated as the control port of the neighbor switch which becomes a new transit switch. The flooding of an LLDP always stops at a neighbor switch or neighbor transit switch. When a neighbor switch is discovered by the controller and placed on the control tree, it now becomes a new transit switch.
5) The control network discovery in our invention is an iterative process because as the controller discovers new neighbor switches and grafts new control connections by designating control ports, it repeats the LLDP process by directing new packet-out (with an LLDP in the payload) messages to newly discovered switches so as to discover their downstream neighbors.
6) The LLDP flooding process establishes, as a by-product, a complete data network topology, while allowing the controller to discover a control tree. The topology discovery is achieved as follows:
   a. Via a transit switch sending a neighbor transit switch's LLDP in a packet-in. Controller infers a connection between the source port (in LLDP) of the neighbor transit switch and the transit switch.
   b. Via a transit switch sending a neighbor switch's hello message in a packet-in. Controller infers a connection between the source port (in hello) of the neighbor switch and the transit switch.
7) Note that along the physical path between the neighbor switch and the controller, there may be several alternative transit switches/tree-paths, each having already configured with a control port/channel towards the controller. Since the controller can obtain information about the quality of network links, it can select the best path for the control. Note that the controller can later collect measurement statistics on the control links and decide to reshape the control tree. Updating the control network topology is out of the scope of the invention.
8) When the controller receives the packet-in with a hello message from a neighbor switch in a packet-in, forwarded by the attached transit switch (which has a control path towards the controller), the controller will attempt to graft a control channel between that transit switch and when the controller responds to the hello message received this way it starts the normal OpenFlow dialogue between the newly discovered switch and the controller. Meanwhile, it will send a control flow table entry to each transit switch on the control path towards the neighbor switch so that they can forward messages between the controller and the neighbor switch to the appropriate control ports. This message will be targeted to the source MAC address of the neighbor switch and traverse along the configured control path towards the transit node attached to the neighbor switch, and therefrom to the source MAC address -noting that the last transit node that generated the packet-in knows the port it arrived.
9) Even when all the switches are connected to the controller with a control tree, the controller will continue to periodically send LLDP messages to each switch as described above in order to update the topology information and discover the switches newly attached to the network.

When the controller discovery process is completed, i.e., all switches in the network have channels towards the controller(s), each switch will also be configured with a control flow table, defining how OpenFlow control packets will be processed. The control flow table also defines how LLDP packets must be processed and forwarded by switches. The discovery process should be treated as an ongoing process.

Multiple Controllers: If there are multiple controllers in the network, each controller will have a different overlay control network. Each such control network can be modeled as a tagged VLAN with a different VID. When a controller starts sending the discovery-message, each receiving transit switch treats the message in that controller's specific VLAN. Meaning, a switch can simultaneously process LLDP packets from different controllers. Doing so, the control trees of different controllers will come out differently.

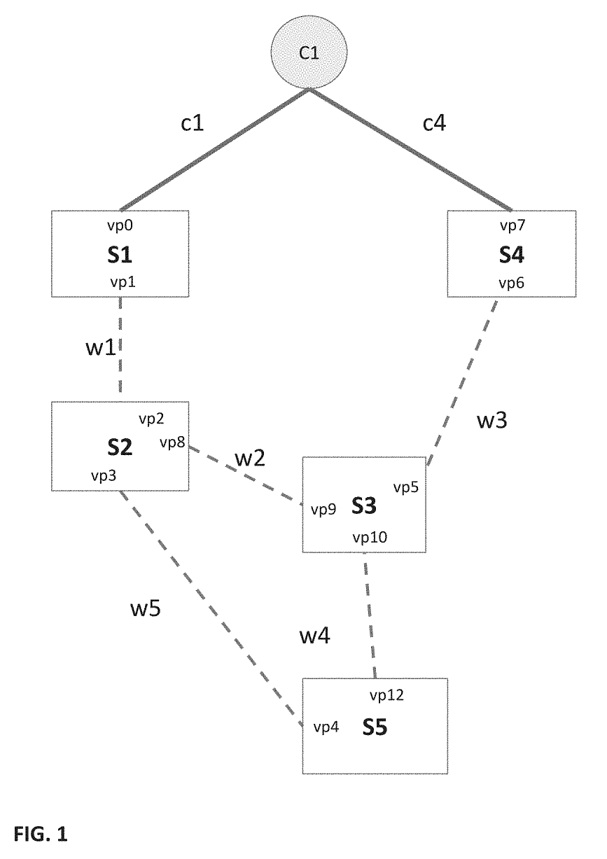

Consider a simple exemplary network illustrated in FIG. 1. There is a single controller, C, and five switches, S1, S2, S3, S4 and S5, wherein the controller is directly attached to switches S1 and S4, with connections c1 and c4, respectively. Switches S2, S3 and S5 are not directly attached to the controller and therefore, initially are neighbor switches of transit switches S1 and S4. The control tree towards these five switches and all the data connections between these switches will be discovered by the controller using the method of this invention as follows:

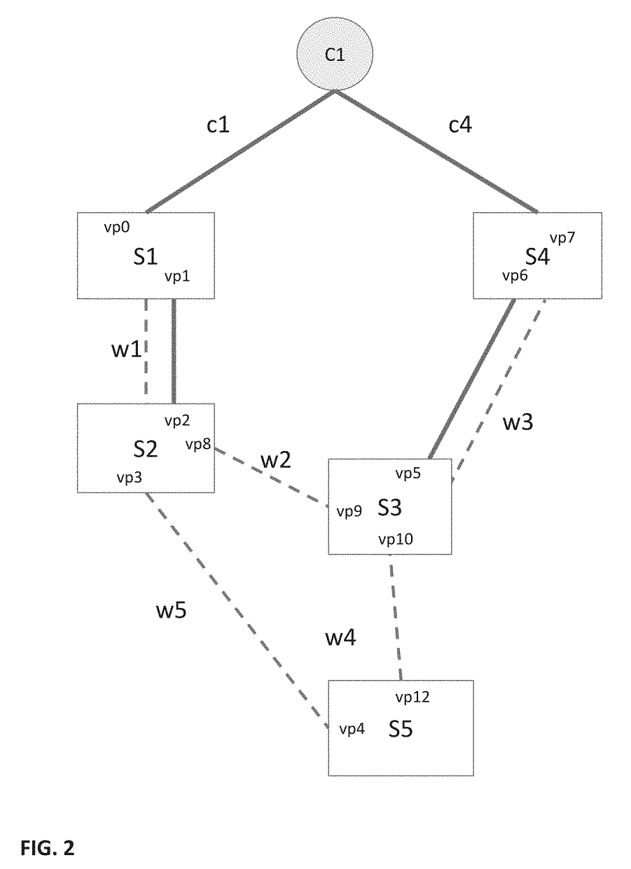

The discovery process starts by controller C generating a packet-out towards S1 and a packet-out towards S4 on the direct control connections c1 and c4, respectively.
S1 receiving the packet-out extracts the LLDP packet and multicasts it to S2. Since S2 is listening to the LLDP multicast address and doesn't have a control connection towards C, it generates a hello message (the source port is vp2) and sends it from the port it received the LLDP message. In turn, S1 generates a packet-in with the received hello message and sends it to the controller. Note that S1 is instructed by the controller to send any hello messages it receives from any of its data ports towards the control port (to reach the controller) in the control flow table. Receiving the hello, controller C designates vp2 as the control port of S2 and responds to the hello message as in the normal OpenFlow dialogue (See FIG. 2). As a by-product, controller C also derives that there is a connection between vp2 and S1.
S4 receiving the packet-out extracts the LLDP message and multicasts it to S3. Since S3 doesn't have a control connection to C, it generates a hello message (the source port is vp5) and sends it from the port it received the LLDP message. In turn, S4 generates a packet-in with the received hello message and sends it to the controller. The controller designates vp5 as the control port of S3 and responds to the hello message as in the normal OpenFlow dialogue (See FIG. 2). Controller also derives that there is a connection between vp5 and S4.

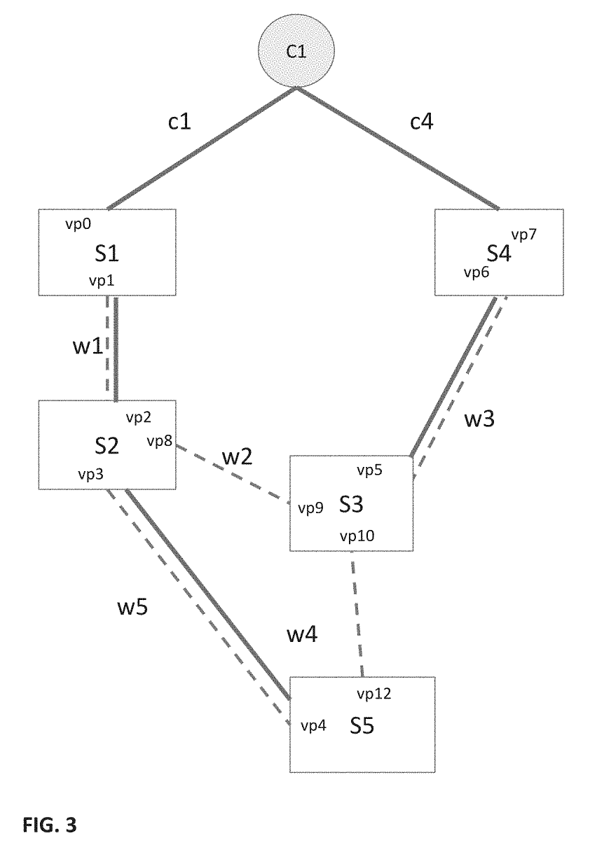

Next cycle: controller C generates a packet-out towards S2 and S3, the new transit switches, and sends them via S1 and S4, respectively.
S2 receiving the packet-out extracts the LLDP and multicasts it to S3 and S5.
   Since S3 is a transit node, it generates a packet-in with the received LLDP message and sends it to the controller. It changes the source MAC address of the LLDP message to that of vp8. The controller derives that there is a data connection between vp8 and S3.
   Since S5 doesn't have a control connection to C yet it generates a hello message (the source port is vp4) and sends it from the port it received the LLDP message. In turn, S2 generates a packet-in with the received hello message and sends it to the controller. The controller designates vp4 as the control port of S5 and responds to the hello message as in the normal OpenFlow dialogue (see FIG. 3). As a by-product, controller C derives that there is a connection between vp4 and S2.
S3 receiving the packet-out extracts the LLDP and multicasts it to S2 and S5.
   Since S2 is a transit node, it generates a packet-in with the received LLDP message and sends it to the controller. It changes the source MAC address of the LLDP message to that of vp9. The controller derives that there is a data connection between vp9 and S2.
   Since S5 is a transit node now, it generates a packet-in with the received LLDP message and sends it to the controller. It changes the source MAC address of the LLDP message to that of vp10. The controller derives that there is a data connection between vp10 and S5.
      Final cycle: controller C generates a packet-out towards S5, the new transit switch, and sends it towards S1.
S5 receiving the packet-out extracts the LLDP and multicasts it to S3.
   Since S3 is a transit node, it generates a packet-in with the received LLDP message and sends it to the controller. It changes the source MAC address of the LLDP message to that of vp12. The controller derives that there is a connection between vp12 and S3.

At this stage, no new neighbor nodes are discovered. Therefore, the control network discovery process is completed. However, the controller will continue to send LLDP messages to the switches periodically in order to update the topology information and discover any switches that are added to the network at a later time.

Although we kept the specific techniques for control network optimization out of scope, it is worthwhile to mention that most controllers will have ways to collect real-time data from switches on the quality of control channels, and compare those with other potential alternatives. These measurements will feed into a control network optimizer in the controller. The controller can initiate a reconfiguration of the control network by sending OpenFlow instructions, if certain poorly performing channels can be switched-over to other better-performing connections.

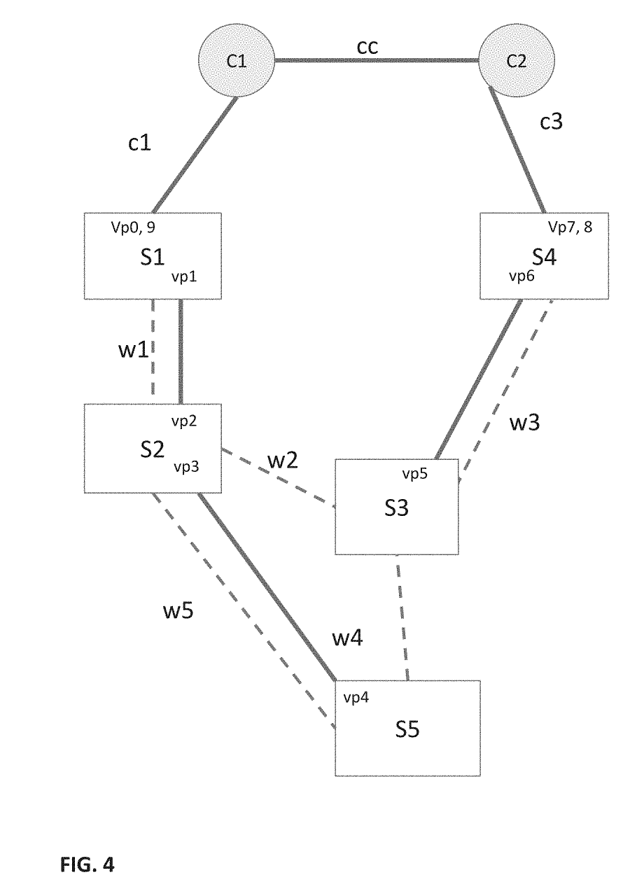

FIG. 4 shows the previous network with two controllers, C1 and C2. This time S1 has a direct physical connection (c1) to C1 and S4 has a direct physical connection (c4) to C2. S2, S3 and S5 will connect to C1 or C2 (or to both of them) through S1 and S4. Two control VLANs are formed, with VID=VLAN1 for C1 and VID=VLAN2 for C2.

When S1 connects to C1, C1 programs S1 to forward the hello packets with VID=VLAN1 to itself and C2 programs S4 similarly for the hello packets with VID=VLAN2. C1 sends an LLDP message in a packet-out with a VLAN tag having VID=VLAN1. When S2 receives the message, it will send a hello message from the port it received the LLDP message with a VLAN tag where VID value is VLAN1; thus distinguishing the overlay control networks from each other by using different VLAN tags provides isolation between them and makes it easier for switches to simultaneously connect to more than one controller when needed.

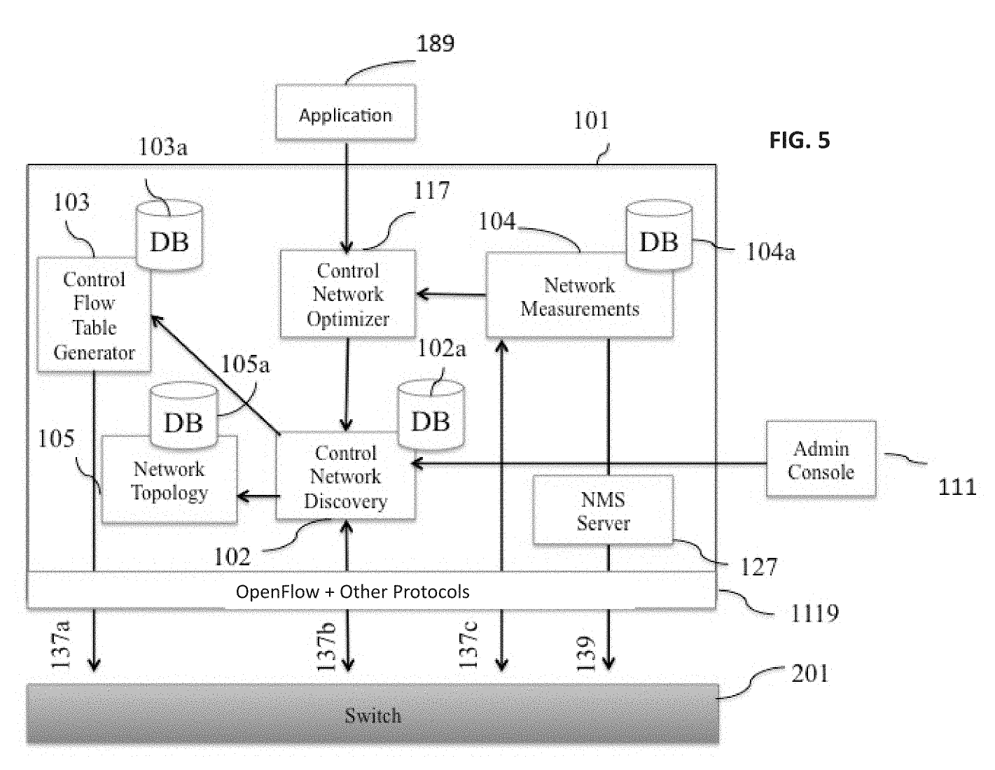

FIG. 5 depicts a high-level block diagram of additional functions needed in the controller to support in-band control network discovery. OpenFlow 1119 is the interface of Controller 101, which sends and receives OpenFlow (in another exemplary implementation, possibly another protocol) messages between Controller 101 and switch 201.

The key functional block for the discovery of the control tree and data network topology is Control Network Discovery module 102 that:
Performs the control network discovery process when the controller is initially booted up or periodically even after the cycle of discovery is completed.
Originates the packet-out messages with an LLDP packet in the payload, and manages the cycle of LLDP floods towards the network;
Receives and processes the packet-in messages received from switch 201 with either LLDP or hello packet in the payload;
Interacts with Control Flow Table Generator 103 to generate new control flow table entries to be sent to switch 201 via OpenFlow 1119;
Collaborates with Network Topology 105 to insert newly learnt data connections and control tree connections as a result of the discovery process into Network Topology Database 105a;
Collaborates with Control Network Optimizer 117 to determine the path for a new control channel if there are multiple options available.

Optimizer 117 periodically evaluates the topology of the control tree by extracting control tree topology from DB 105s, and makes a determination if any adjustments are needed to make the tree perform better based on network statistics collected by Control Network Measurements 104, which collects real-time network performance data from the switches via OpenFlow 1119. DB 104a contains the raw data as well as the processed data on each link's quality.

Admin console 111 communicates with Control Network Discovery 102 to modify network discovery parameters, or it can manually initialize control port activation on switches for a new controller.

Control Flow Table Generator 103 obtains the most recent control network topology and determines required control flow table entries per switch. This information is stored in DB 103a. Control Flow Table Generator sends the instructions to activate control flow tables to each switch with an OpenFlow message on interface 137a. Interface 137b is where a packet-out is sent according to OpenFlow to a switch. Controller 101 queries network switches for performance measurements using interface 137c. Any network management commands to the switches are sent on interface 139 from NMS server 127 or optionally using OpenFlow. Application 189 communicates with controller 101 to provide specific network requirements to Control Network Optimizer 117.

Network Topology 105 is responsible for extracting and keeping current the entire data network topology as well as control tree topology (per controller) in the SDN by collaborating with Controller Discovery 102. Each time a new connection is uncovered between a pair of nodes via packet-in messages received from switches, it is added to the Topology Database 105b. The network topology discovery is, therefore, an incremental process. Since the control network discovery cycle is an ongoing process, the network topology is continuously updated.

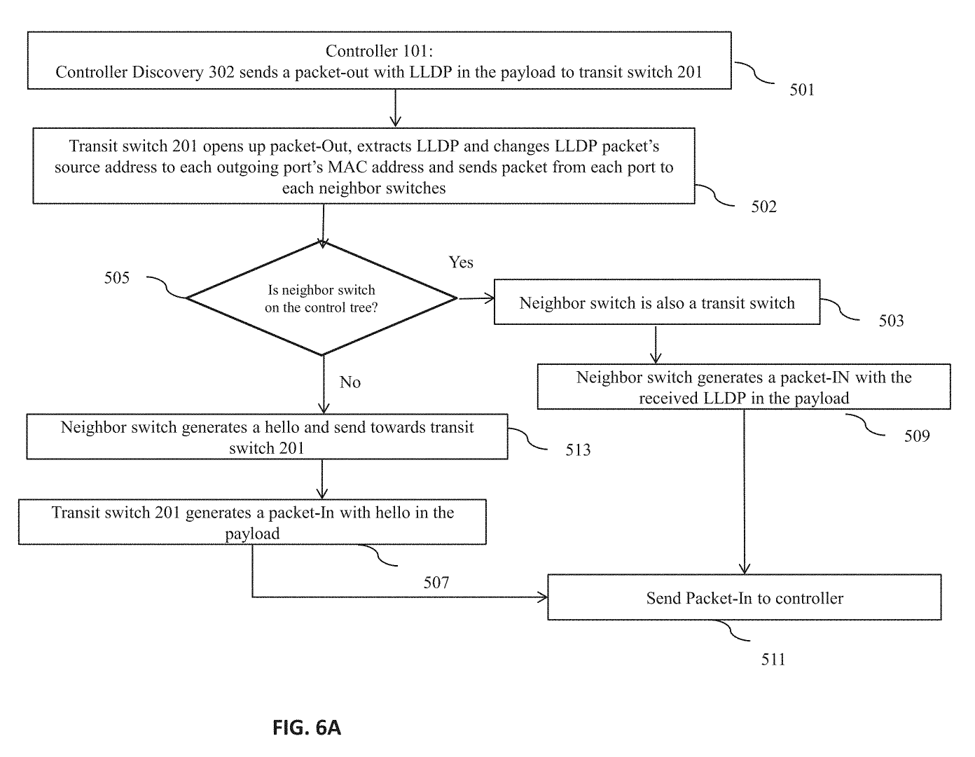

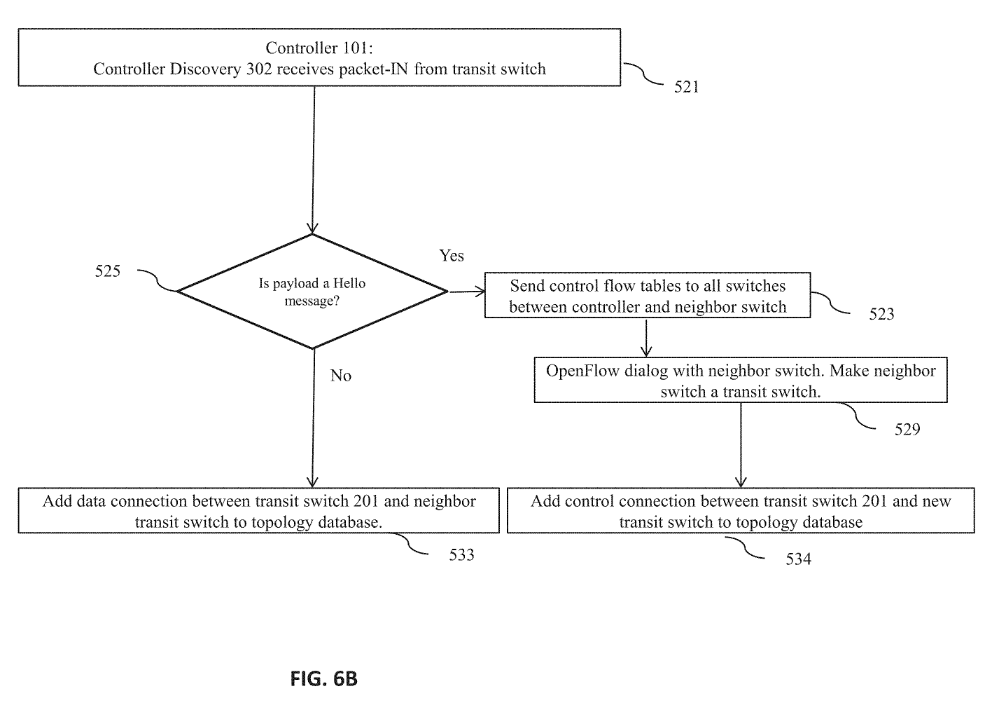

A simple high-level flow-chart illustrating the method of this invention is illustrated in FIGS. 6a and 6b. The process starts at step 501 in FIG. 6a, in which the controller sends packet-out message with an LLDP in the payload to a transit switch 201. Transit switch multicasts the packet to all its neighbors. At step 502, the process branches out. If the switch receiving the packet is a neighbor switch that is not a transit switch in step 503, neighbor switch generates a hello message and send towards transit switch 201. In turn, transit switch 201 sends a packet-in with the hello message in the payload to the controller in step 507. If the switch receiving the packet is another transit switch, it generates a packet-in with the payload being the LLDP message. In step 511, the packet-in is sent to the controller. In FIG. 6b, controller 101 receives the packet-in and sends to the payload to control discovery 302. In step 525, it checks to determine if the payload is a hello message. If it is not a hello, it adds the connection between transit switch 201 and the other transit switch to the topology database 105b in step 533. Otherwise, in step 523, controller 101 sends additional control flow tables instructing the switch how to forward packets between the neighbor switch and the controller to all switches between the neighbor switch and the controller in step 529. In step 534, it adds the control connection between the neighbor switch and transit switch 201 to topology database.

Many of the above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

In this specification, the term “software” is meant to include firmware residing in read-only memory or applications stored in magnetic storage or flash storage, for example, a solid-state drive, which can be read into memory for processing by a to processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

### CONCLUSION

A controller subsystem and a method for in-band control network discovery in a Software Defined Network (SDN) using a controller-originated discovery process is described. This process, as a byproduct, discovers the entire data network topology. The method is applicable in SDNs wherein out-of-band (direct) connections from the controller to every switch in the network are not economical or feasible as in radio networks and specifically in wireless mesh networks. The invented discovery process is compliant with the current architecture of SDN. The discovery process is periodically repeated by the controller. Furthermore, using a software capability in the controller, the in-band control network topology can be re-adjusted and even optimized by analyzing the performance of the links carrying control channels. For multi-controller SDN scenarios a Virtual LAN (VLAN) per controller with a tree topology wherein the root is a controller and edges are switch-to-switch virtual overlay channels is proposed.

1. A method as implemented in a controller in a software defined network (SDIN), the controller storing an in-band control tree, the control tree spanning switches as an overlay to the SDN with the controller as the root of the control tree, the controller connected to at least a transit switch in the control tree, and the transit switch having at least one, first-degree, neighbor transit switch also in the control tree and having at least another, first-degree, neighbor switch that is not in the control tree, the method comprising:
a. transmitting, to the transit switch, a packet-out message with an LLDP packet as its payload, wherein the transit switch: receives the packet-out message, extracts the LLDP packet from its payload, and multicasts the LLDP packet through all its active ports to the neighbor transit switch and neighbor switch;
b. receiving, from the neighbor transit switch in the control tree, a first packet-in message, with the first packet-in message being generated by the neighbor transit switch using the received LLDP packet as the payload;
c. receiving, from the neighbor switch not in the control tree, a second packet-in message with a hello message as its payload, with the second packet-in message being sent over the same port in the neighbor switch that received the LLDP packet transmitted in (a) and via the transit switch connected to the controller which then forwards the second packet-in message to the controller;
d. adding a new link to the control tree for the neighbor switch that sent the second packet-in message in (c).

2. The method of claim 1, wherein the controller communicates with the neighbor switch via OpenFlow after the new link is added in the control tree.

3. The method of clam 1, wherein the control tree is a virtual LAN (VLAN).

4. The method of clam 3, wherein the VLAN is a tagged port based VLAN.

5. The method of clam 3, wherein VLAN is different for each controller serving the SDN.

6. The method of clam 1, wherein the control tree is a packet flow carrying control traffic.

7. The method of claim 1, wherein, in the LLDP packet in the packet-out message, a source address field is set to an outgoing switch port's MAC address.

8. The method of claim 1, wherein packet-in messages are an OpenFlow packet-in message.

9. The method of claim 1, wherein packet-in messages are unicast messages.

10. The method of claim 1, wherein the packet-out is a unicast message.

11. A method as implemented in a transit switch in a software defined network (SDN), the SDN further comprising a controller storing an in-band control tree, the control tree spanning switches as an overlay to the SDN with the controller as the root of the control tree, the controller connected to at least the transit switch in the control tree, and the transit switch having at least one, first-degree, neighbor transit switch also in the control tree and having at least another, first-degree, neighbor switch that is not in the control tree, the method comprising:
a. receiving, from the controller, a packet-out message with an LLDP packet as its payload;
b. extracting the LLDP packet from the payload of the packet-out message;
c. multicasting the LLDP packet through all active ports of the transit switch to the neighbor transit switch and neighbor switch, wherein the neighbor transit switch in the control tree generates and transmits, to the controller, a first packet-in message using the received LLDP packet as the payload;
d. receiving a second packet-in message from a neighbor switch not in the control tree, with the neighbor switch generating and transmitting the packet-in message with a hello message as its payload, where the packet-in message is sent over the same port in the neighbor switch that received the LLDP packet transmitted in (c); and
e. forwarding the packet-in message to the controller,
wherein the container adds a new link to the control tree for the neighbor switch that sent the second packet-in message.

12. The method of claim 11, wherein the controller communicates with the neighbor s itch via OpenFlow after the new link is added in the control tree.

13. The method of claim 11, wherein the control tree is a virtual LAN (VLAN),

14. The method of claim 13, wherein the VLAN is a tagged port based VLAN.

15. The method of claim 13, wherein VLAN is different for each controller serving the SDN.

16. The method of claim 11, wherein the control tree is a packet flow carrying control traffic.

17. The method of claim 11, wherein, in the LLDP packet in the packet-out message, a source address field is set to an outgoing switch port's MAC address.

18. The method of claim 11, wherein packet-in messages are an OpenFlow packet-in message.

19. A controller in a software defined network (SDN), the controller storing an in-band control tree, the control tree spanning switches as an overlay to the SDN with the controller as the root of the control tree, the controller connected to at least a transit switch in the control tree, and the transit switch having at least one, first-degree, neighbor transit switch also in the control tree and having at least another, first-degree, neighbor switch that is not in the control tree, the controller comprising:
a. a control discovery subsystem, which initiates and manages control network discovery, and: (1) generates and transmits, to the transit switch, a packet-out message with an LLDP packet as its payload, wherein the transit switch: receives the packet-out message, extracts the LLDP packet from its payload, and multicasts the LLDP packet through all its active ports to the neighbor transit switch and neighbor switch, (2) receives, from the neighbor transit switch in the control tree, a first packet-in message, with the first packet-in message being generated by the neighbor transit switch using the received LLDP packet as the payload, and (3) receives, from the neighbor switch not in the control tree, a second packet-in message with a hello message as its payload, with the second packet-in message being sent over the same port in the neighbor switch that received the LLDP packet transmitted in (1) and via the transit switch connected to the controller which then forwards the second packet-in message to the controller;
b. a topology discovery subsystem that derives the existence of connections between switches based on received first and second packet-in messages by the control discovery subsystem; and
c. a topology database storing data network and control tree topologies.

20. The system of claim 19, wherein the controller further comprises a control network optimizer which evaluates the control tree and initiates reconfiguration of the control tree.

21. The system of claim 19, wherein the controller further comprises a control network measurement collector which collects measurements from switches in the SDN to evaluate quality of existing in-band control channels.

22. The system of claim 19, wherein the controller further comprises a control flow table generator which generates a control flow table for each switch in the control tree.
